(19) United States
(12) Patent Application Publication
(10) Pub. No.: US 2007/0288684 A1
(43) Pub. Date: Dec. 13, 2007

(54) Quantum circuit for quantum state discrimination

(75) Inventors: Janos Bergou, East Brunswick, NJ (US); Mark Hillery, Metuchen, NJ (US)

Correspondence Address: OPTICUS IP LAW, PLLC, 7791 ALISTER MACKENZIE DRIVE, SARASOTA, FL, 34240, US

(73) Assignee: MagiQ Technologies, Inc.

(21) Appl. No.: 11/788,705

(22) Filed: Apr. 20, 2007

Related U.S. Application Data
(60) Provisional application No. 60/794,708, filed on Apr. 25, 2006.

(51) Int. Cl. G06F 17/00

(52) U.S. Cl. 711/101

(57) ABSTRACT

The invention is a quantum circuit that unambiguously discriminates between two unknown quantum states of qubits. The circuit receives the qubits in the unknown states as inputs, or programs, in first and second program registers. A data register also receive a third qubit prepared in one of the two states stored in the program registers. The circuit, with some probability of success, determines which unknown state of the qubit in the data register matches the state stored in the first or second program registers. The optimal circuit, i.e., one that maximizes the probability of success, is universal because it does not depend on the actual unknown states to be discriminated. The quantum circuit has industrial applicability to quantum information, and in particular to quantum computing.

### CLAIM OF PRIORITY

This application claims priority under 35 USC § 119(e) from U.S. Provisional Patent Application Ser. No. 60/794,708, which application is incorporated herein by reference in its entirety.

### STATEMENT OF GOVERNMENT RIGHTS

This invention was made in part with U.S. Government support under grant PHY 01339692 from the National Science Foundation. The U.S. Government may therefore have certain rights in this invention.

### TECHNICAL FIELD OF THE INVENTION

The invention relates to quantum information processing and quantum computing, in particular it relates to a quantum circuit for quantum state discrimination.

### BACKGROUND ART

Quantum computing exploits unique quantum features of quantum bits or “qubits” to perform computation operations much faster than classical computers. While a classical bit stores information in one of two possible logical states (e.g., 0 and 1), a qubit is able to simultaneously store information about the two possible logic states due to the principle of quantum superposition. Thus, a qubit is able to stores more information per bit than a classical bit. A quantum register of n qubits is thus able to store 2ⁿ bits of information, as opposed to n bits for a classical register formed from n classical bits. Further, since a quantum register stores a superposition of bits, simultaneous computing operations can be performed.

In practice, qubits are formed from molecules, particles, or other systems that can maintain information as a superposition of quantum states. The quantum state superposition represents quantum state information. For example, a particle such as an atom, ion or an electron may exist in a simultaneous superposition of spin-up and spin-down states, unlike a conventional bit that must be either on or off. Examples of qubits have been demonstrated in nuclear magnetic resonance systems, described in Chuang et al. in Physics Review Letters 80, 3408 (1998) and Jones et al. in Nature (London) 393, 344 (1998), and optical systems, described by Kwiat et al. in Optics 47, 257 (1999). In addition, implementations of qubits in cavity quantum electrodynamic systems have also been proposed. The book entitled “The physics of quantum information” by Bouwmeester, Ekert and Zeilinger (eds.), Springer-Verlag (2001) (ISBN 3-540-66778-4) discusses the basics of quantum computation and different ways qubits and quantum gates can be formed.

Like a classical computer formed from sequences of classical logic gates, a quantum computer is formed from sequences of quantum logic gates designed to carry out a particular quantum algorithm. An assembly of one or more quantum gates designed to carry out a particular operation constitutes a “quantum circuit.” An example of a quantum circuit designed for performing a particular algorithm called “Grover's algorithm” is set forth in U.S. Pat. No. 7,028,275 to Chen et al. (the '275 patent), which patent is incorporated herein by reference. Grover's algorithm involves searching for an object in unsorted data containing N elements. Classically such a search requires on the average, O(N) searches. However, Grover showed that, by employing quantum superposition and quantum entanglement, the search can be carried out with only O(N^{1/2}) steps, which represents a polynomial advantage over classical counterparts.

The quantum circuit design for Grover's algorithm set forth in the '275 patent initializes a collection of qubits by generating a superposition of quantum states in each of the qubits, inverts the sign of a target quantum state, and calculates an inversion about the average for each qubit using one-bit unitary gates and two-bit quantum phase gates. The inverting and calculating steps are iterated to determine a search result corresponding to the object being sought, i.e., a target quantum state.

Quantum measurements are crucial part of any quantum device, particularly quantum circuits and computers. The superpositional nature of quantum states, however, makes it difficult if not impossible to employ classical measurement techniques to determine quantum states. In classical physics, one can readily compare two systems by measuring a number of observables (parameters) of each system and finding differences and similarities in the measurement results. There are two main reasons why this approach does not work for quantum systems governed by quantum physics. First, one cannot measure simultaneously all observables of each system. Second, when measuring a single observable one may obtain different results even if two systems were prepared in the same state. A conclusive result is achieved by measuring the observables only if many copies of the systems are available. In quantum information processing, only a single pair of the system (e.g., a pair of qubits in a register having a number of qubits) is available for comparison.

Further, it may be advantageous to process information in a quantum information processing device, such as a quantum computer, and provide the output of processing steps as qubits encoded in unknown states in a simple way.

Accordingly new methods and techniques are needed to obtain information about states of quantum systems that can be used for system identification and recognition.

### SUMMARY OF THE INVENTION

An aspect of the present invention is a programmable discriminator quantum circuit that unambiguously discriminates between two unknown quantum states. The circuit receives the unknown states as inputs, or programs, in first and second program registers. A data register also receive a third system prepared in one of the two states stored in the program registers. The device, with some probability of success, determines whether the unknown state in the data register matches the state stored in the first or second program registers. The optimal device, i.e., one that maximizes the probability of success, is universal because it does not depend on the actual unknown states to be discriminated.

### BRIEF DESCRIPTION OF THE DRAWING

FIG. 1 is a flow diagram of the basis steps of the method of the present invention;

FIGS. 2A and 2B are a schematic diagrams of example embodiments of the programmable discriminator quantum circuit of the present invention;

FIG. 3 is a schematic diagram of an example optical implementation of a Hadamard gate;

FIG. 4 is a schematic diagram of an example optical implementation of a controlled NOT (CNOT) gate;

FIG. 5 is a schematic diagram that applies two additional Hadamard gates (H) to a CMINUS gate to build a CNOT gate;

FIG. 6 is a schematic diagram of an example optical implementation of a CSWAP gate;

FIG. 7 is a schematic diagram of a CSWAP gate; and

FIG. 8 is a schematic diagram of an example optical implementation of a Toffoli gate.

The various elements depicted in the drawing are merely representational and are not necessarily drawn to scale. Certain sections thereof may be exaggerated, while others may be minimized. The drawing is intended to illustrate an example embodiment of the invention that can be understood and appropriately carried out by those of ordinary skill in the art.

### DETAILED DESCRIPTION OF THE INVENTION

The present invention relates to quantum mechanical systems, and in particular relates to system and methods for unambiguously discriminating between two unknown quantum states |ψ₁ [symbol] and |ψ₂ [symbol] of a quantum system. The present invention has industrial utility for applications based on quantum systems, such as quantum computing.

The mathematical basis for the methods of the programmable discriminator according to the present invention is first set forth in Section I. An example physical implementation of the programmable discriminator in the form of a quantum circuit is then described in Section II.

I. Mathematical Basis for the Method

The mathematical basis for the methods of the present invention is described in the publication by Janos Bergou and Mark Hillery, entitled “A universal programmable quantum state discriminator that is optimal for unambiguously distinguishing between unknown quantum states,” (Bergou I) first published at arXiv.quant-ph/0504201 on Apr. 25, 2005, which publication is incorporated by reference herein, and which publication serves as the basis for the discussion set forth immediately below.

Given two unknown quantum states, |ψ₁ [symbol] and |ψ₂ [symbol] , one can construct a device (e.g., a quantum circuit, as discussed below) that unambiguously discriminates between them. If this device is given a system in one of these two states, it will produce one of three outputs, 1, 2, or 0. If the output is 1, then the input was |ψ₁ [symbol] , if the output is 2, then the input was |ψ₂ [symbol] , and if the output is 0, which we call failure, then we learn nothing about the input. The device will not make an error, it will never give an output of 2 if the input was |ψ₁ [symbol] , and vice versa. This strategy is called “unambiguous discrimination.” The input states are not necessarily orthogonal; in fact, they can be completely arbitrary within the constraint that they are linearly independent (see, e.g., A. Chefles, Phys. Lett. A, 239, 339 (1998)). The cost associated with this condition is that the probability of receiving the output 0 (failure) is not zero. The minimum value of this probability for two known and equally likely states is | [symbol] ψ₁|ψ₂ [symbol] | (see, e.g., I. D. Ivanovic, Phys. Lett. A, 123, 257 (1987); D. Dieks, Phys. Lett. A, 126, 303 (1988); A. Peres, Phys. Lett. A, 128, 19 (1988)).

The actual state-distinguishing device for two known states depends on the two states, |ψ₁ [symbol] and |ψ₂ [symbol] , i.e., these two states are “hard wired” into the machine. The goal is to construct a machine in which the information about |ψ₁ [symbol] and |ψ₂ [symbol] is supplied in the form of a program. This machine would be capable, with the correct program, of distinguishing any two quantum states. One such device has been proposed by Du\check{s}ek and Bu\check{z}ek (see M. Du\check{s}ek and V. Bu\check{z}ek, Phys. Rev. A, 66, 022112 (2002)). This device distinguishes the two states cos(φ/2)|0 [symbol] ±sin(φ/2)|1. The angle φ is encoded into a one-qubit program state in a somewhat complicated way. The performance of this device is good. It does not achieve the maximum possible success probability for all input states, but its success probability, averaged over the angle φ, is greater than 90% of the optimal value.

In a series of recent works, Fiurá\check{s}ek et al. investigated a closely related programmable device that can perform a von Neumann projective measurement in any basis, the basis being specified by the program. Both deterministic and probabilistic approaches were explored (see J. Fiurasek, M. Dusek, and R. Filip, Phys. Rev. Lett., 89, 190401 (2002); J. Fiurasek and M. Dusek, Phys. Rev. A, 69, 032302 (2004)), and experimental versions of both the state discriminator and the projective measurement device were realized (see J. Soubusta, A. Cernoch, J. Fiurasek, and M. Duzek, Phys. Rev. A, 69, 052321 (2004)). Sasaki et al. developed a related device, which they called a quantum matching machine (see M. Sasaki and A. Carlini, Phys. Rev. A, 66, 022303 (2002); M. Sasaki, A. Carlini, and R. Jozsa, Phys. Rev. A, 64, 022317 (2001)). Its input consists of K copies of two equatorial qubit states, which are called templates, and N copies of another equatorial qubit state |f [symbol] . The device determines to which of the two template states |f [symbol] is closest. This device does not employ the unambiguous discrimination strategy, but rather optimizes an average score that is related to the fidelity of the template states and |f [symbol] . Programmable quantum devices to accomplish other tasks have recently been explored by a number of authors.

A goal of the present invention is to construct a programmable state discriminating machine whose program is related in a simple way to the states |ψ₁ [symbol] and |ψ₂ [symbol] to be distinguished. A motivation for doing so is that the program state may be the result of a previous set of operations in a quantum information processing device, and if would be easier to produce a state in which the information about |ψ₁ [symbol] and |ψ₂ [symbol] is encoded in a simple way rather than one in which the encoding is more complicated.

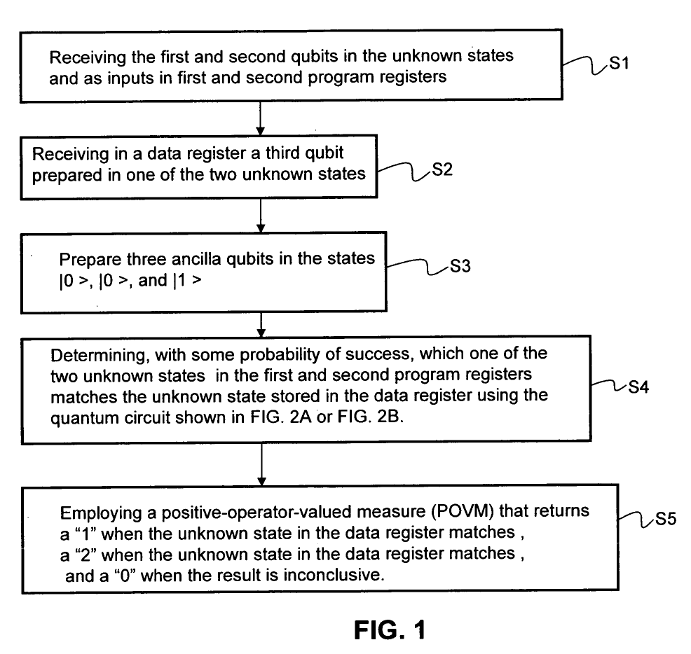

A simple version of a programmable state discriminator is now described. The basic program (method) is outlined in the flow diagram of FIG. 1 and the steps S1-S5 therein. The program consists of the two qubit states to be distinguished. In other words, two qubits, one in the state |ψ₁ [symbol] and another in the state |ψ₂ [symbol] are provided. We have no knowledge of the states |ψ₁ [symbol] and |ψ₂ [symbol] . Then a third qubit is provided that is guaranteed to be in one of the two program states, and the task is to determine, as best as possible, in which one. We are allowed to fail, but not to make a mistake. What is the best procedure to accomplish this?

We shall consider the first two qubits we are given as a program. They are fed into the program register of some device, called the programmable state discriminator (Step S1), and the third, unknown qubit is fed into the data register of this device (Step S2). The method includes in a Step 3 preparing three ancilla qubits in the states |0>, |0>, and |1> (discussed in Section II, below). The device then tells us, with optimal probability of success, which one of the two program states the unknown state of the qubit in the data register corresponds (Step S4). We can design such a device by viewing our problem as a task in measurement optimization. We want to find a measurement strategy that, with maximal probability of success, will tell us which one of the two program states, stored in the program register, matches the unknown state, stored in the data register. Our measurement is allowed to return an inconclusive result but never an erroneous one. Thus, in Step S5 a POVM (positive-operator-valued measure) is employed that returns a 1 (the unknown state stored in the data register matches |ψ₁ [symbol] ), a 2 (the unknown state stored in the data register matches |ψ₂ [symbol] ), or a 0 (we do not learn anything about the unknown state stored in the data register).

Our task is then reduced to the following measurement optimization problem. One has two input states

$${{{{{{\vert {Ψ}_{1}^{i n} 〉 = \vert {ψ}_{1} 〉}_{A} \vert {ψ}_{2} 〉}_{B} \vert {ψ}_{1} 〉}_{C} , \\ \vert {Ψ}_{2}^{i n} 〉 = \vert {ψ}_{1} 〉}_{A} \vert {ψ}_{2} 〉}_{B} \vert {ψ}_{2} 〉}_{C} , \qquad ( 1 )$$

where the subscripts A and B refer to the program registers (A contains |ψ₁ [symbol] and B contains |ψ₂ [symbol] ), and the subscript C refers to the data register. Our goal is to unambiguously distinguish between these inputs' keeping in mind that one has no knowledge of |ψ₁ [symbol] and |ψ₂ [symbol] , i.e., we want to find a POVM that will accomplish this.

Let the elements of our POVM be Π₁, corresponding to unambiguously detecting |Ψ₁ⁱⁿ [symbol] , Π₂, corresponding to unambiguously detecting |Ψ₂ⁱⁿ [symbol] , and Π₀, corresponding to failure. The probabilities of successfully identifying the two possible input states are given by

$$〈 {Ψ}_{1}^{i n} \vert {\prod }_{1} \vert {Ψ}_{1}^{i n} 〉 = {p}_{1} , 〈 {Ψ}_{2}^{i n} \vert {\prod }_{2} \vert {Ψ}_{2}^{i n} 〉 = {p}_{2} , \qquad ( 2 )$$

and the condition of no errors implies that

$${\prod }_{2} \vert {Ψ}_{1}^{i n} 〉 = 0 , {\prod }_{1} \vert {Ψ}_{2}^{i n} 〉 = 0. \qquad ( 3 )$$

In addition, because the alternatives represented by the POVM exhaust all possibilities, we have that
I=Π₁+Π₂+Π₀. (4)

The fact that we know nothing about |ψ₁ [symbol] and |ψ₂ [symbol] means that the only way we can guarantee satisfying the above conditions is to take advantage of the symmetry properties of the states, i.e. that |Ψ₁ⁱⁿ [symbol] is invariant under interchange of the first and third qubits, and |Ψ₂ⁱⁿ [symbol] is invariant under interchange of the second and third qubits. That unknown states can be unambiguously compared with a non-zero probability of success, using symmetry considerations only, has been first pointed out by Barnett et al. (see S. M. Barnett, A. Chefles, and I. Jex, Phys. Left. A, 307, 189 (2003)). In our case, we require that Π₁ give zero when acting on states that are symmetric in qubits B and C, while Π₂ give zero when acting on states that are symmetric in qubits A and C. Defining the antisymmetric states for the corresponding pairs of qubits

$${{{{{{\vert {ψ}_{BC}^{( - )} 〉 = \frac{1}{\sqrt{2}} {( \vert 0 〉}_{B} \vert 1 〉}_{C} - \vert 1 〉}_{B} \vert 0 〉}_{C} ) , \\ \vert {ψ}_{A C}^{( - )} 〉 = \frac{1}{\sqrt{2}} {( \vert 0 〉}_{A} \vert 1 〉}_{C} - \vert 1 〉}_{A} \vert 0 〉}_{C} ) , \qquad ( 5 )$$

we introduce the projectors to the antisymmetric subspaces of the corresponding qubits as

$${P}_{BC}^{as} = \vert {ψ}_{BC}^{( - )} 〉 〈 {ψ}_{BC}^{( - )} \vert , {P}_{A C}^{as} = \vert {ψ}_{A C}^{( - )} 〉 〈 {ψ}_{A C}^{( - )} \vert . \qquad ( 6 )$$

We can now take for Π₁, and Π₂ the operators

$${\prod }_{1} = {c}_{1} {I}_{A} ⊗ {P}_{BC}^{as} , {\prod }_{2} = {c}_{2} {I}_{B} ⊗ {P}_{A C}^{as} , \qquad ( 7 )$$

where I_{A} and I_{B} are the identity operators on the spaces of qubits A and B, respectively, and c₁ and c₂ are as yet undetermined nonnegative real numbers. The no-error condition dictates that

$${\prod }_{1} = {Q}_{A} ⊗ {P}_{BC}^{as} and {\prod }_{2} = {Q}_{B} ⊗ {P}_{A C}^{as} ,$$

and it can be shown that the unknown operators Q_{A} and Q_{B} can be chosen to be proportional to the identity. Using the above expressions for Πⱼ, where j=1, 2 in Eq.(2), we find that

$${p}_{j} = 〈 {Ψ}_{j}^{i n} \vert {\prod }_{j} \vert {Ψ}_{j}^{i n} 〉 = {c}_{j} \frac{1}{2} ( 1 - \vert 〈 {ψ}_{1} \vert {ψ}_{2} 〉 {\vert}^{2} ) . \qquad ( 8 )$$

The average probability, P, of successfully determining which state we have, assuming that the input states occur with a probability of η₁ and η₂, respectively, is given by

$$P = {η}_{1} {p}_{1} + {η}_{2} {p}_{2} = \frac{1}{2} ( {η}_{1} {c}_{1} + {η}_{2} {c}_{2} ) ( 1 - \vert 〈 {ψ}_{1} \vert {ψ}_{2} 〉 {\vert}^{2} ) , \qquad ( 9 )$$

and we want to maximize this expression subject to the constraint that Π₀=I−Π₁−Π₂ is a positive operator.

Let S be the four-dimensional subspace of the entire eight-dimensional Hilbert space of the three qubits, A, B, and C, that is spanned by the vectors

$${{{{\vert 0 〉}_{A} \vert {ψ}_{BC}^{( - )} 〉 , \vert 1 〉}_{A} \vert {ψ}_{BC}^{( - )} 〉 , \vert 0 〉}_{B} \vert {ψ}_{A C}^{( - )} 〉 , and \vert 1 〉}_{B} \vert {ψ}_{A C}^{( - )} 〉 .$$

In the orthogonal complement of S, S^{⊥}, the operator Π₀ acts as the identity, so that in S^{⊥}, Π₀ is positive. Therefore, we need to investigate its action in S. First, let us construct an orthonormal basis for S. Applying the Gram-Schmidt process to the four vectors, given above, that span S, we obtain the orthonormal basis

$$\begin{matrix}{\vert {Φ}_{1} 〉 = \vert 0 〉}_{A} \vert {ψ}_{BC}^{( - )} 〉 , \\ {\vert {Φ}_{2} 〉 = \frac{1}{\sqrt{3}} {( 2 \vert 0 〉}_{B} \vert {ψ}_{A C}^{( - )} 〉 - \vert 0 〉}_{A} \vert {ψ}_{ BC}^{( - )} 〉 ) , \\ {\vert {Φ}_{3} 〉 = \vert 1 〉}_{A} \vert {ψ}_{BC}^{( - )} 〉 , \\ {\vert {Φ}_{4} 〉 = \frac{1}{\sqrt{3}} {( 2 \vert 1 〉}_{B} \vert {ψ}_{A C}^{( - )} 〉 - \vert 1 〉}_{A} \vert {ψ}_{BC}^{( - )} 〉 ) .\end{matrix} \qquad ( 10 )$$

In this basis, the operator Π₀, restricted to the subspace S, is given by the 4×4 matrix

$${\prod }_{0} = ( \begin{matrix}1 - {c}_{1} - \frac{1}{4} {c}_{2} & - \frac{\sqrt{3}}{4} {c}_{2} & 0 & 0 \\ - \frac{\sqrt{3}}{4} {c}_{2} & 1 - \frac{3}{4} {c}_{2} & 0 & 0 \\ 0 & 0 & 1 - {c}_{1} - \frac{1}{4} {c}_{2} & - \frac{\sqrt{3}}{4} {c}_{2} \\ 0 & 0 & - \frac{\sqrt{3}}{4} {c}_{2} & 1 - \frac{3}{4} {c}_{2}\end{matrix} ) . \qquad ( 11 )$$

Because of the block diagonal nature of Π₀, the characteristic equation for its eigenvalues, λ, is given by the biquadratic equation

$${[ {λ}_{2} - ( 2 - {c}_{1} - {c}_{2} ) λ + 1 - {c}_{1} - {c}_{2} + \frac{3}{4} {c}_{1} {c}_{2} ]}^{2} = 0. \qquad ( 12 )$$

It is easy to obtain the eigenvalues explicitly. For our purposes, however, the conditions for their nonnegativity are more useful. These can be read out from the above equation, yielding

$$2 - {c}_{1} - {c}_{2} \geq 0 , 1 - {c}_{1} - {c}_{2} + \frac{3}{4} {c}_{1} {c}_{2} \geq 0. \qquad ( 13 )$$

The second is the stronger of the two conditions. When it is satisfied the first one is always met but the first one can still be used to eliminate nonphysical solutions. We can use the second condition to express c₂ in terms of c₁,

$${c}_{2} \leq \frac{1 - {c}_{1}}{1 - ( 3 / 4 ) {c}_{1}} . \qquad ( 14 )$$

For maximum probability of success, we chose the equal sign. Inserting the resulting expression into Eq.(9) gives

$$P = \frac{1}{2} ( {η}_{1} {c}_{1} + {η}_{2} \frac{1 - {c}_{1}}{1 - ( 3 / 4 ) {c}_{1}} ) ( 1 - \vert 〈 {ψ}_{1} \vert {ψ}_{2} 〉 {\vert}^{2} ) . \qquad ( 15 )$$

We can easily find c₁=c_{1,opt}, where the right-hand side of this expression is maximum and using this together with Eq.(14) we obtain

$${c}_{1 , opt} = \frac{2}{3} ( 2 - \sqrt{\frac{{η}_{2}}{{η}_{1}}} ) {c}_{2 , opt} = \frac{2}{3} ( 2 - \sqrt{\frac{{η}_{2}}{{η}_{1}}} ) . \qquad ( 16 )$$

Inserting these optimal values into Eq.(9) gives

$${P}_{POVM} = \frac{2}{3} ( 1 - \sqrt{{η}_{1} {η}_{2}} ) ( 1 - \vert 〈 {ψ}_{1} \vert {ψ}_{2} 〉 {\vert}^{2} ) . \qquad ( 17 )$$

This is not the full story, however. The above expression is valid only when c_{1,opt} and c_{1,opt} are both non-negative. From Eq.(16) it is easy to see that this holds if

$$\frac{1}{5} \leq {η}_{1} , {η}_{2} \leq \frac{4}{5} . \qquad ( 18 )$$

In order to understand what happens outside this interval, we have to turn our attention to the detection operators. Using c_{1,opt} and c_{1,opt}. in Eq.(7) yields

$${\prod }_{1 , opt} = \frac{2}{3} ( 2 - \sqrt{\frac{{η}_{2}}{{η}_{1}}} ) {I}_{A} ⊗ {P}_{BC}^{as} , \\ {\prod }_{2 , opt} = \frac{2}{3} ( 2 - \sqrt{\frac{{η}_{1}}{{η}_{2}}} ) {I}_{B} ⊗ {P}_{A C}^{as} . \qquad ( 19 )$$

For

$${η}_{1} = 4 / 5 ( and {η}_{2} = 1 / 5 ) , {Π}_{1 , opt} = {I}_{A} {P}_{BC}^{as} and {Π}_{2 , opt} = 0.$$

This structure then remains valid for η₁≧4/5. In other words, when the first input dominates the preparation it is advantageous to use the full projector that distinguishes it with maximal probability of success, p_{1,opt}=(1−| [symbol] ψ₁|ψ₂ [symbol] |²)/2, at the expense of sacrificing the second input completely, p_{2,opt}=0. These values yield the average success probability,

$${P}_{1} = \frac{1}{2} {η}_{1} ( 1 - {\vert 〈 {ψ}_{1} \vert {ψ}_{2} 〉 \vert}^{2} ) , \qquad ( 21 )$$

for η₁≧4/5. Conversely, for

$${η}_{2} = 4 / 5 , {Π}_{2 , opt} = {I}_{B} {P}_{A C}^{as} and {Π}_{1 , opt} = 0.$$

This structure then remains valid for η₂≧4/5. So, when the second input dominates the preparation it is advantageous to use the full projector that distinguishes it with maximal probability of success, p_{2,opt}=(1−| [symbol] ψ₁|ψ₂ [symbol] |²)/2, at the expense of sacrificing the first input completely, p_{1,opt}=0. These values yield the average success probability,

$${P}_{2} = \frac{1}{2} {η}_{2} ( 1 - {\vert 〈 {ψ}_{1} \vert {ψ}_{2} 〉 \vert}^{2} ) , \qquad ( 21 )$$

for η₂≧4/5. As we see, the situation is fully symmetric in the inputs and a priori probabilities. In the intermediate range, neither one of the inputs dominates the preparation, and we want to identify them as best as we can, so the POVM solution will do the job there. Our findings can be summarized as follows

$${P}^{opt} = \{ \begin{matrix}{P}_{POVM} & if & \frac{1}{5} \leq {η}_{1} \leq \frac{4}{5} , \\ {P}_{2} & if & {η}_{1} < \frac{1}{5} , \\ {P}_{1} & if & \frac{4}{5} < {η}_{1} .\end{matrix} \qquad ( 22 )$$

Equation (22) represents our main result. In the intermediate range of the a priori probability the optimal failure probability, Eq.(17), is achieved by a generalized measurement or POVM. Outside this region, for very small a priori probability, η₁≦1/5, when the preparation is dominated by the second input, or very large a priori probability, η₁≧4/5, when the preparation is dominated by the first input, the optimal failure probabilities, Eqs. (20) and (21), are realized by standard von Neumann measurements. For very small η₁ the optimal von Neumann measurement is a projection onto the antisymmetric subspace of the A and C qubits. For very large η₁ the optimal von Neumann measurement is a projection onto the antisymmetric subspace of the B and C qubits. At the boundaries of their respective regions of validity, the optimal measurements transform into one another continuously. We also see that the results depend on the overlap of the unknown states only. If we do not know the states but we know their overlap then Eqs. (17), (20), and (21) immediately give the optimal solutions for this situation. If we know nothing about the states, not even their overlap, then we average these expressions over all input states, which results in the factor, 1−| [symbol] ψ₁|ψ₂ [symbol] |², being replaced by its average value of ½. Then we have the optimum average probabilities of success in the various regions. This situation is shown in FIG. 1 of Bergou I.

In its range of validity the POVM performs better than any von Neumann measurement that does not introduce errors. From the figure it also can be read out that the difference between the performance of the POVM and that of the von Neumann projective measurements is largest for η₁=η₂=½. For these values

$${P}_{POVM}^{ave} = 1 / 6$$

while P₁^{ave}=⅛ so the POVM represents a 33% improvement over the standard quantum measurement.

Finally, one should note a striking feature of the programmable state discriminator. Neither the optimal detection operators nor the boundaries for their region of validity, Eqs. (18) and (19), depend on the unknown states. Therefore, our device is universal, it will perform optimally for any pair of unknown states. Only the probability of success for fixed but unknown states will depend on the overlap of the states.

This POVM provides us with the best procedure for solving the problem posed earlier. It also demonstrates the role played by a priori information. This device has a smaller success probability than one designed for a case in which we know one of the input states, which in turn has a smaller success probability than one designed for the case when we know both possible input states. While its success probability is lower than that for a device that distinguishes known states, the device discussed here is more flexible. All of the information about the states is carried by a quantum program, which means that it works for any two states. Consequently, it can be used as part of a larger device that produces quantum states that need to be unambiguously identified.

II. Example Physical Implementation

The article by Bergou and Orzag entitled “Physical implantation of a programmable discriminator for unknown quantum states,” published in J. Opt. Soc. Am. B 24, 384-390 (2007) (Bergou II), which article is incorporated herein by reference, includes a quantum circuit analysis in connection with a physical implementation of the programmable state discriminator of the present invention.

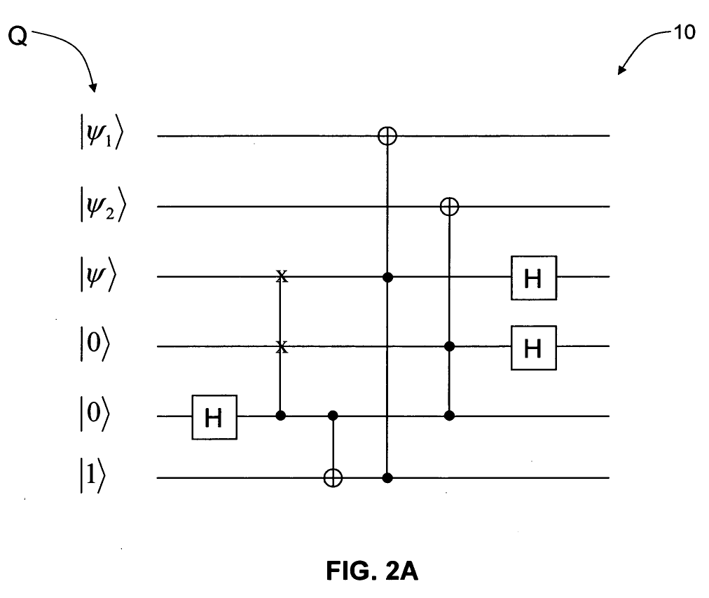

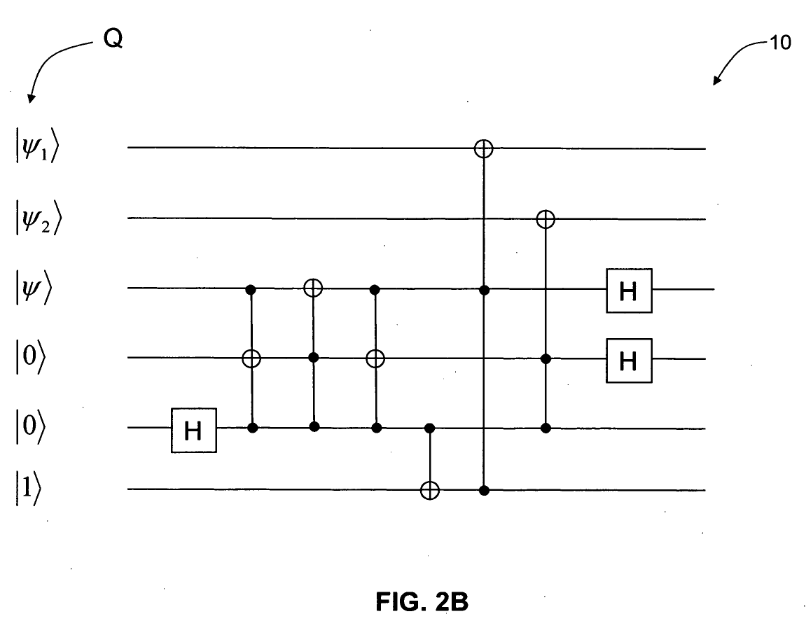

FIGS. 2A and 2B are schematic diagrams example embodiments of a programmable discriminator quantum circuit 10. Circuit 10 is constructed from elementary quantum gates that have been analyzed theoretically and demonstrated experimentally in many areas of quantum information processing.

Circuit 10 includes a set of six qubits Q arranged in first through six registers, respectively. The input state for the six qubits is
|ψᵢₙ [symbol] =|ψ₁ [symbol] |ψ₂ [symbol] |ψ [symbol] |0 [symbol] |0 [symbol] |1 [symbol] , (23)
with
|ψ₁ [symbol] =α₁|0 [symbol] +β₁|1 [symbol] ,
|ψ₂ [symbol] =α₂|0 [symbol] +β₂|1 [symbol] ,
|ψ [symbol] =γ|0 [symbol] +δ|1 [symbol] .
|ψ₁ [symbol] and |ψ₂ [symbol] are the two unknown states and |ψ [symbol] is the data state. The numbering of qubits in FIG. 2 is from top to bottom, with the first called “1” and the last called “6.” This is the outside index and it does not refer to the state of that qubit at the input. The last three qubits act as ancilla qubits (Step S3).

The parameters |αᵢ [symbol] and |βᵢ [symbol] of |ψ₁ [symbol] and |ψ₂ [symbol] are unknown. The parameters of the state |ψ [symbol] in the third register, however, match either those of the state in the first register (so that γ=α₁ and δ=β₁ in this case) or the parameters of the state in the second register (so that γ=α₂ and δ=β₂ in this case). In other words, the state in the third register is either identical to the state in the first register or it is identical to the state in the second register. That means that we have two possible input states
|ψ₁ [symbol] =|ψ₁ [symbol] |ψ₂ [symbol] |ψ₁ [symbol] , (24)
or
|ψ_{Π} [symbol] =|ψ₁ [symbol] |ψ₂ [symbol] |ψ₂ [symbol] , (25)

Circuit 10 then compares the content of the third register, called the data register, to the contents of the first and second registers, called the program registers. Circuit 10 determines with a certain probability of success which one of the two program states the data state matches. Otherwise, circuit 10 returns an inconclusive answer. The key is that the states in the registers are completely unknown and one never learns what they are. All one learns from this is that the unknown state in the data register matches the unknown state in the first program register or it matches the unknown state in the second program register or, as a third option, one does not learn which one it matches.

Since this is a choice between two alternatives, it is perfectly adequate to communicate a zero (match with first program state) or 1 (match with second program state), i.e., a full qubit, using completely unknown states. All that is explored here is the symmetry of the two inputs. The first is symmetric in the content of the first and third register and the second is symmetric in the content of the second and third register, independently of the actual states in those registers. The states can be completely random, and can even change. All that is required is that the inputs be symmetric.

Circuit 10 is universal in the sense that it is independent of the actual parameters of the states. This is as it should be, since those parameters are unknown. The circuit utilizes the symmetry properties of the two inputs because that is the only information known about them.

Applying the gates of the state discriminator of quantum circuit 10, the following result is obtained:

$$\begin{matrix}{( H )}_{3} {( H )}_{4} {( T )}_{542} {( T )}_{631} {( CNOT )}_{56} {( CSWAP )}_{345} {( H )}_{5} \vert {ψ}_{i n} 〉 & ( 26 ) \\ = \frac{1}{\sqrt{2}} \{ \begin{matrix}\frac{{α}_{1} γ + {β}_{1} δ}{\sqrt{2}} {\vert 00 〉}_{13} + \frac{{α}_{1} γ - {β}_{1} δ}{\sqrt{2}} {\vert 01 〉}_{13} \\ \frac{+ {α}_{1} δ + {β}_{1} γ}{\sqrt{2}} {\vert 10 〉}_{13} - \frac{{α}_{1} δ - {β}_{1} γ}{\sqrt{2}} {\vert 11 〉}_{13}\end{matrix} \} {\vert {ψ}_{2} 〉}_{2} {\vert 001 〉}_{456} & \\ + \frac{1}{\sqrt{2}} \{ \begin{matrix}\frac{{α}_{2} γ + {β}_{2} δ}{\sqrt{2}} {\vert 00 〉}_{24} + \frac{{α}_{2} γ - {β}_{2} δ}{\sqrt{2}} {\vert 01 〉}_{24} \\ \frac{+ {α}_{2} δ + {β}_{2} γ}{\sqrt{2}} {\vert 10 〉}_{24} - \frac{{α}_{2} δ - {β}_{2} γ}{\sqrt{2}} {\vert 11 〉}_{24}\end{matrix} \} {\vert {ψ}_{1} 〉}_{1} {\vert 001 〉}_{456} . & \end{matrix}$$

where (H)ᵢ is the Hadamard gate, (T)ᵢⱼₖ is the Toffoli gate, (CNOT)ᵢⱼ is the CNOT gate, (CSWAP)ᵢⱼₖ is the CSWAP gate. The sub-indices denote the number of qubits.

In the discrimination process there are two choices of parameters, either γ=α₁ and δ=β₁ or γ=α₂ and δ=β₂. The fourth term in the first bracket on the right-hand side of the above expression becomes zero for the first choice and the fourth term in the second bracket on the right-hand side becomes zero for the second choice. This implies that for a reading of |11 [symbol] ₁₃ in the qubits 1 and 3, then the unknown state is |ψ₂ [symbol] , and if for a reading of |11 [symbol] ₂₄ in the qubits 2 and 4, then the unknown state is |ψ₁ [symbol] . In all other cases, we get no information about the unknown state.

Implementation of the Quantum Gates

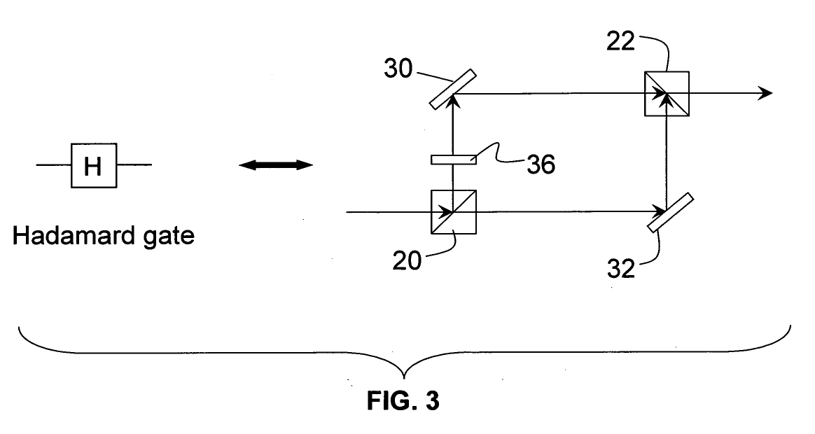

FIG. 3 is a schematic optical diagram illustrating an example optical implementation of a Hadamard that employs two beam splitters 20 and 22, two mirrors 30 and 32, and a half-wave plate 36 arranged to form a simple interferometer.

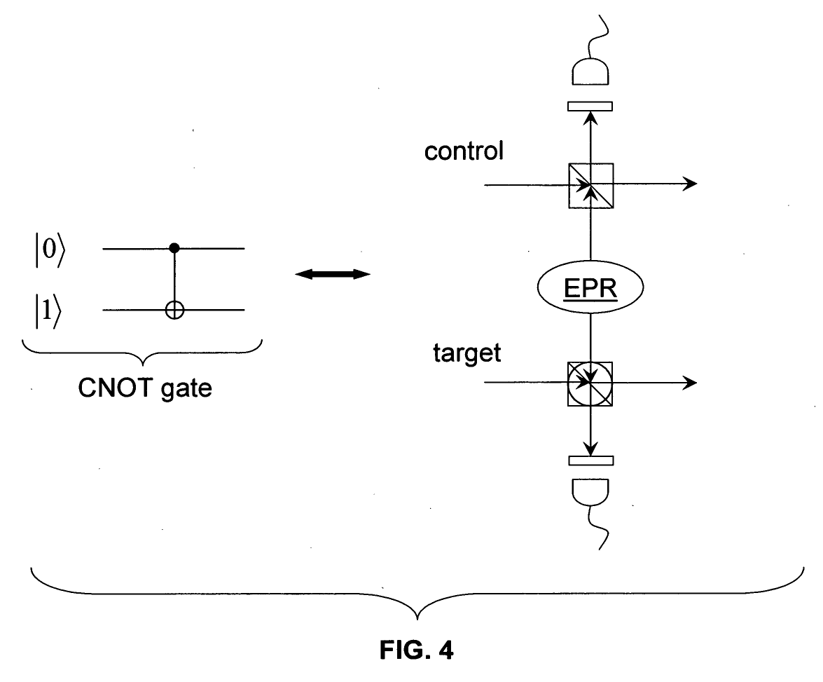

FIG. 4 is a schematic optical diagram illustrating an example optical implementation of a Controlled NOT (CNOT) gate. An ancilla EPR pair is required in this particular embodiment (see Z. Zhao et al., “Experimental Demonstration of a Nondestructive Controlled-NOT Quantum Gate for Two Independent Photon Qubits,” Phys. Rev. Left. 94, 030501 (2005), and S. Gasparoni, et al., “Realization of a Photonic Controlled-NOT Gate Sufficient for Quantum Computation,” Phys. Rev. Lett. 93, 020504 (2004)).

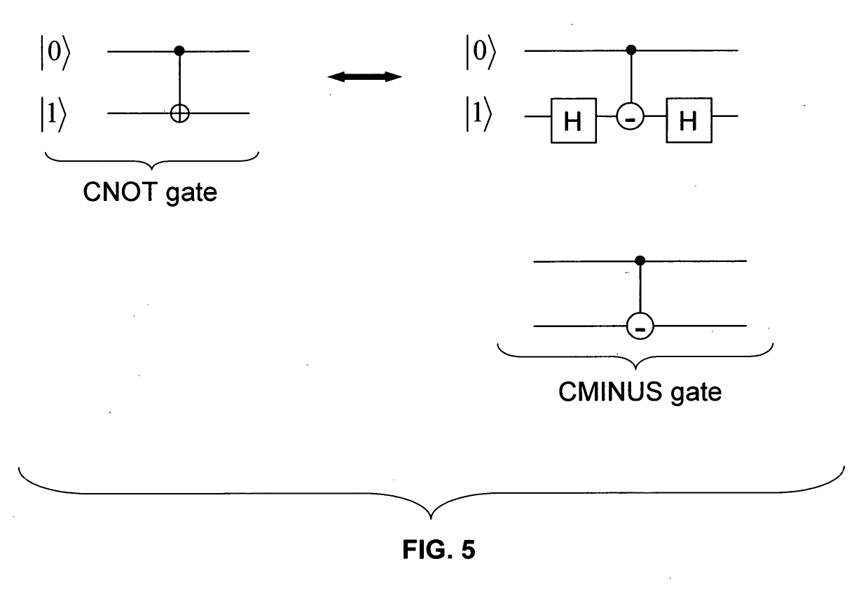

There is a gate, called a CMINUS gate or Controlled Phase gate, that is related to the CNOT gate. Linear-optics embodiments of a CMINUS gate are discussed in the article by N. K. Langford et al., “Demonstration of a Simple Entangling Optical Gate and Its Use in Bell-State Analysis,” Phys. Rev. Lett. 95, 210504 (2005), as well as in the article by N. Kiesel, et al., “Linear Optics Controlled-Phase Gate Made Simple,” Phys. Rev. Lett. 95, 210505 (2005), and in the article by R. Okamoto, et al., “Demonstration of an Optical Quantum Controlled-NOT Gate without Path Interference,” Phys. Rev. Lett. 95, 210506 (2005). The CMINUS gate has very simple relation to CNOT gate. FIG. 5 is a schematic diagram that applies two additional Hadamard gates (H) to a CMINUS gate to build a CNOT gate.

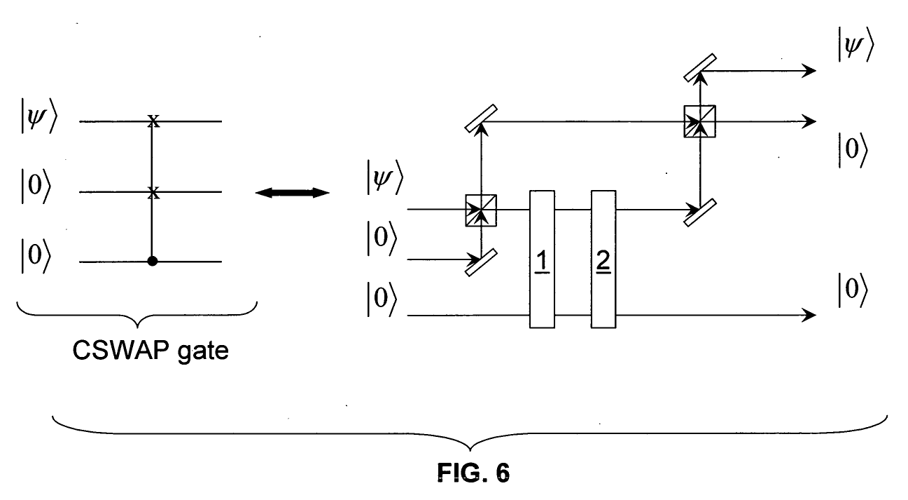

FIG. 6 is a schematic diagram of an example embodiment of an optical implementation of a Controlled SWAP (CSWAP) gate, as proposed in the article by J. Fiurasek, entitled “Linear optics quantum Toffoli and Fredkin gates,” published at Arxiv.quant-ph/0602220 (2006). The CSWAP gate of FIG. 6 is based on a balanced Mach-Zehnder interferometer, wherein elements 1 and 2 provide conditional phase shifts π to the vertically, 1, and horizontally, 2, polarized photons in the lower arm of the interferometer.

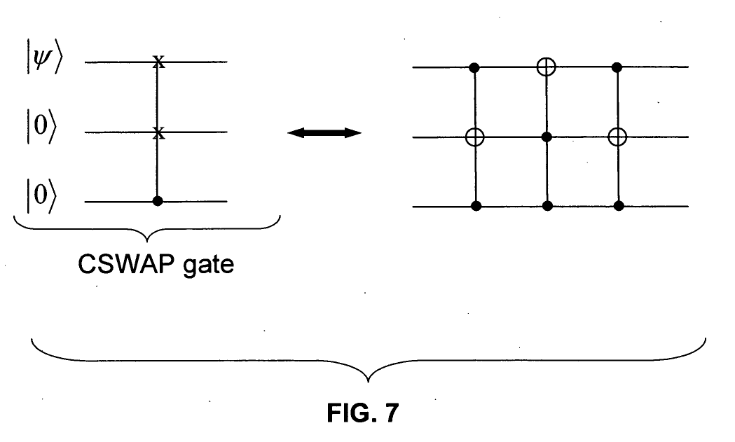

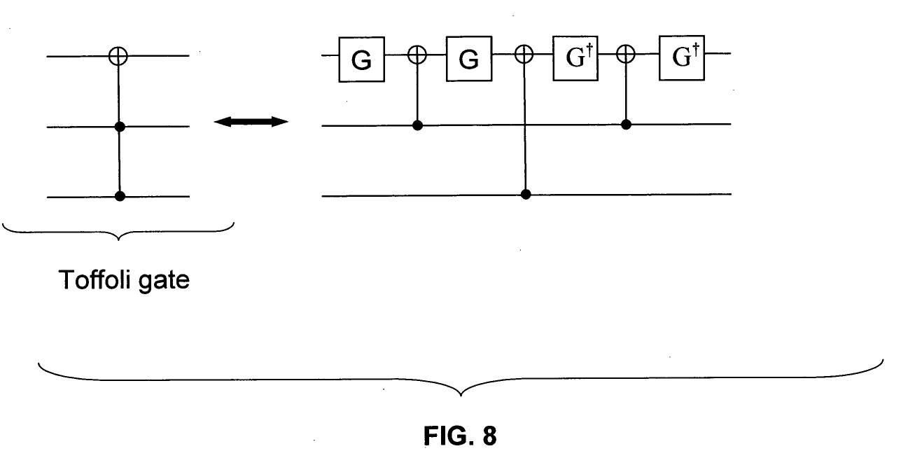

The CSWAP or Fredkin gate can be also constructed from three Toffoli gates as shown schematically in FIG. 7. A Toffoli gate itself can be efficiently build from three CNOT gates and single qubit rotations as shown in FIG. 8 (see A. Barenco et al., Elementary gates for quantum computation, Phys. Rev. A, 52, 3457(1995)). In FIG. 8, G is a single-qubit rotation by π/4.

A Toffoli gate changes the value of the target qubit if both control qubits are in the |1 [symbol] state and does nothing otherwise. That is T|011 [symbol] →|111 [symbol] and T|111 [symbol] →|011 [symbol] and the other six basis states do not change, target is the first qubit, controls are the second and third ones.

While the present invention has been described above in connection with preferred embodiments, it will be understood that it is not so limited. On the contrary, it is intended to cover all alternatives, modifications and equivalents as may be included within the spirit and scope of the invention as defined in the appended claims.

What is claimed is:

1. A method of unambiguously discriminating between two unknown quantum states |ψ₁ [symbol] and |ψ₂ [symbol] of first and second qubits, comprising:
receiving the first and second qubits in the unknown states |ψ₁ [symbol] and |ψ₂ [symbol] as inputs in first and second program registers;
receiving in a data register a third qubit prepared in one of the two unknown states |ψ₁ [symbol] and |ψ₂ [symbol] ;
determining, with some probability of success, which one of the two unknown states in the first and second program registers matches the unknown state stored in the data register; and
wherein said determining may return an inconclusive result but not an erroneous result.

2. The method of claim 1, including employing a positive-operator-valued measure (POVM) that returns a “1” when the unknown state in-the data register matches |ψ₁ [symbol] , a “2” when the unknown state in the data register matches |ψ₂ [symbol] , and a “0” when the result in inconclusive.

3. A quantum circuit that unambiguously discriminates between two unknown quantum states |ψ₁ [symbol] and |ψ₂ [symbol] of first and second qubits, comprising:
first and second program registers adapted to receive and store first and second qubits in the unknown states |ψ₁ [symbol] and |ψ₂ [symbol] as inputs;
a data register adapted to receive a third qubit prepared in one of the two unknown states |ψ₁ [symbol] and |ψ₂ [symbol] ;
measurement means for determining, with some probability of success, which one of the two unknown states in the first and second program registers matches the unknown state stored in the data register, wherein the measurement means may return an inconclusive result but not an erroneous result.

4. The quantum circuit of claim 3, wherein said measurement means employs a positive-operator-valued measure (POVM) that returns a “1” when the unknown state in the data register matches |ψ₁ [symbol] , a “2” when the unknown state in the data register matches |ψ₁ [symbol] , and a “0” when the result in inconclusive.
